(19) United States
(12) Patent Application Publication
(10) Pub. No.: US 2015/0050947 A1
(43) Pub. Date: Feb. 19, 2015

(54) SUPPORTING LOCATION BASED OPERATIONS

(71) Applicants: Lauri Aarne Johannes Wirola, Tampere (FI); Tommi Antero Laine, Tampere (FI); Jari Syrjarinne, TAMPERE (FI)

(72) Inventors: Lauri Aarne Johannes Wirola, Tampere (FI); Tommi Antero Laine, Tampere (FI); Jari Syrjarinne, TAMPERE (FI)

(21) Appl. No.: 14/383,554

(22) PCT Filed: Mar. 15, 2012
(86) PCT No.: PCT/IB2012/051224

§ 371 Date: Sep. 6, 2014

(51) Int. Cl. H04W 4/02; G01S 5/02

(52) U.S. Cl. CPC H04W 4/023; G01S 5/0252
USPC 455/456.1

(57) ABSTRACT

An apparatus performs continuous measurements on terrestrial signals transmitted by nodes of a communication network to obtain results of measurements. Furthermore, the apparatus continuously determines a position of the mobile device based on the results of measurements at the mobile device and based on data stored in the mobile device, the data including data on characteristics of nodes of at least one communication network that are based at least partly on results of measurements at a plurality of mobile devices on terrestrial signals transmitted by nodes of the at least one communication network.

### FIELD OF THE DISCLOSURE

The invention relates to the field of location based operations, and more specifically to supporting such location based operations.

### BACKGROUND

A user of a mobile device may be interested in various functions that are linked to a particular location.

For instance, a user of a laptop may prefer using his home wireless local access network (WLAN) instead of a cellular communication network for accessing the Internet when being at home. The laptop may scan for signals of an access point (AP) of the home WLAN in order to be able to access the home WLAN whenever the user enters an area covered by the home WLAN.

In another example, a user of a smart phone may wish to make use of a WLAN based positioning. This is only possible, when the smart phone is located in an area, in which signals from at least one suitable WLAN access point can be detected. The smart phone might scan for signals of suitable WLAN access points, in order to be able to make use of a WLAN based positioning whenever possible.

In yet another example, a user of a tablet computer might wish to make use of a service offered by a digital living network alliance (DLNA) compliant device, for instance a digital media server or a digital media printer. DLNA defines interoperability guidelines, which enable a sharing of digital content between consumer devices. The tablet computer may only connect to the DLNA compliant device when it is “visible”, that is, when the tablet computer is sufficiently close to the DLNA compliant device.

It is to be understood that there are many more functions of mobile devices that could be linked in some way to a particular location.

### SUMMARY OF SOME EMBODIMENTS OF THE INVENTION

A method is described, which comprises at a mobile device performing continuous measurements on terrestrial signals transmitted by nodes of a communication network to obtain results of measurements. The method further comprise continuously determining a position of the mobile device based on the results of measurements at the mobile device and based on data stored in the mobile device, the data including data on characteristics of nodes of at least one communication network that are based at least partly on results of measurements at a plurality of mobile devices on terrestrial signals transmitted by nodes of the at least one communication network.

Moreover a first apparatus is described, which comprises means for realizing the actions of the presented method.

The means of this apparatus can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

Moreover a second apparatus is described, which comprises at least one processor and at least one memory including computer program code, the at least one memory and the computer program code configured to, with the at least one processor, cause a mobile device at least to perform the actions of the presented method.

Moreover a non-transitory computer readable storage medium is described, in which computer program code is stored. The computer program code causes a mobile device to realize the actions of the presented method when executed by a processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the computer program code by itself has to be considered an embodiment of the invention.

Moreover a system is described, which comprises any of the described apparatuses and at least one server configured to collect and process results of measurements at a plurality of mobile devices on signals transmitted by nodes of the at least one communication network, and to provide at least a subset of resulting data to the mobile device.

Any of the described apparatuses may comprise only the indicated components or one or more additional components.

Any of the described apparatuses may be a module or a component for a device, for example a chip. Alternatively, any of the described apparatuses may be a device, for instance a mobile terminal.

In one embodiment, the described methods are information providing methods, and the described first apparatus is an information providing apparatus. In one embodiment, the means of the described first apparatus are processing means.

In certain embodiments of the described methods, the methods are methods for supporting the use of location based operations. In certain embodiments of the described apparatuses, the apparatuses are apparatuses for supporting the use of location based operations.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an apparatus according to an exemplary embodiment of the invention;

FIG. 2 is a flow chart illustrating a method according to an exemplary embodiment of the invention;

FIG. 3 is a schematic block diagram of a system according to an exemplary embodiment of the invention;

FIG. 4 is a flow chart illustrating an exemplary operation in the system of FIG. 3;

FIG. 5 is a diagram illustrating variations of a positioning using cell characteristics; and

FIG. 6 is a diagram illustrating an exemplary error distribution in a cell based continuous positioning.

### DETAILED DESCRIPTION OF THE FIGURES

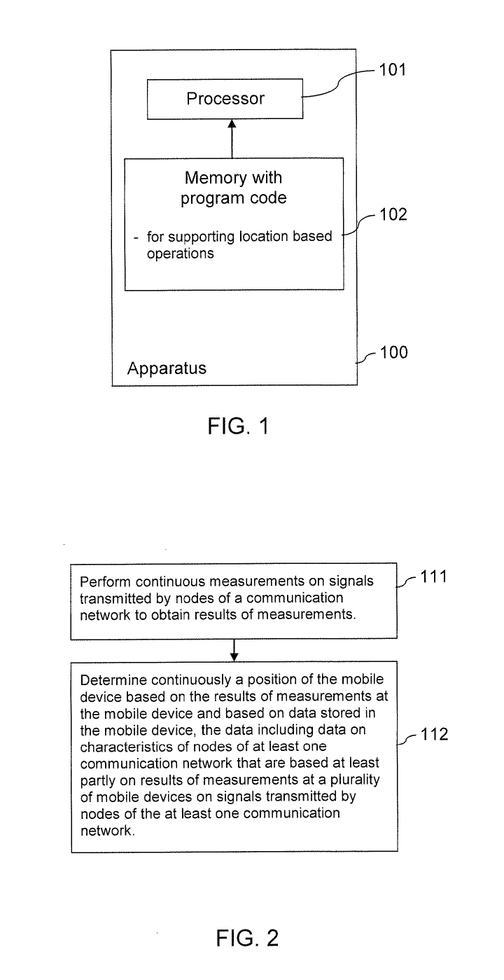

FIG. 1 is a schematic block diagram of an apparatus 100. Apparatus 100 comprises a processor 101 and, linked to processor 101, a memory 102. Memory 102 stores computer program code for supporting the use of location based operations. Processor 101 is configured to execute computer program code stored in memory 102 in order to cause a mobile device to perform desired actions.

Apparatus 100 could be for instance a mobile phone, in particular a smart phone, or any other mobile device that is suited to perform measurements on signals from nodes of a communication network, for instance a laptop or a tablet computer. Apparatus 100 could equally be a module for a mobile device, like a chip, circuitry on a chip or a plug-in board. Apparatus 100 is an exemplary embodiment of any apparatus according to the invention. Optionally, apparatus 100 could have various other components, like a data interface, a user interface, a further memory, a further processor, etc.

An operation of apparatus 100 will now be described with reference to the flow chart of FIG. 2. The operation is an exemplary embodiment of a method according to the invention. Processor 101 and the program code stored in memory 102 cause a mobile device to perform the operation when the program code is retrieved from memory 102 and executed by processor 101. The mobile device that is caused to perform the operation can be apparatus 100 or a mobile device comprising apparatus 100.

The mobile device performs continuous measurements on terrestrial signals transmitted by nodes of a communication network to obtain results of measurements. (action 111)

The mobile device furthermore continuously determines a position of the mobile device based on the results of measurements at the mobile device and based on data stored in the mobile device. The data include data on characteristics of nodes of at least one communication network that are based at least partly on results of measurements at a plurality of mobile devices on terrestrial signals transmitted by nodes of the at least one communication network. (action 112)

Global cellular and non-cellular positioning technologies may be based on generating large global databases containing information on cellular and/or non-cellular signals. The information may originate entirely or partially from users of these positioning technologies.

The information provided by users may be in the form of “fingerprints”, which contain a location that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network signals, as an example of signals of a non-cellular system, the results of the measurements may contain a basic service set identification (BSSID), like the medium access control (MAC) address of observed access points, the service set identifier (SSID) of the access points, and the signal strength of received signals (received signal strength indication RSSI or physical Rx level in dBm with a reference value of 1 mW, etc.).

This data may then be transferred to a server or cloud, where the data may be collected and where further models may be generated based on the data for positioning purposes. Such further models can be coverage area estimates, base station positions and/or radio channel models, a base station being an exemplary node of a communication network. A radio channel model for a node may consists for instance of a node position and a pathloss model, or a plurality of pathloss models in the case of sectorized models. In the end, these refined models may be used for estimating the position of mobile terminals.

Certain embodiments of the invention now provide that a mobile device makes use of such or similar crowd sourced data. The data is stored in a mobile device and used together with continuous measurements on signals from nodes of a communication network at the mobile device for performing a continuous positioning of the mobile device.

Due to the use of stored information on characteristics of nodes, certain embodiments of the invention may have the effect that frequent communication of the mobile device with a network for obtaining a position or positioning assistance data can be avoided. This may save network resources, costs for the data transfer and/or processing power.

Certain embodiments of the invention may have the effect that a dependency on a particular operator of a communication network is reduced, since stored data that is based on crowd sourcing may comprise information on characteristics of nodes of different communication networks. This may be of particular interest in the case of roaming.

Certain embodiments of the invention may have the effect that a continuous location awareness of the mobile device is achieved. This may also reduce the risk of missing a location of interest.

Also mobile device with GNSS capability may benefit from using a continuous positioning that is based on terrestrial signals. A position that is based on measurements on terrestrial signals from nodes of a communication network may be used, for instance, for accelerating the time-to-first-fix in a GNSS based positioning, using the obtained position as reference location, or in order to reduce the power consumption. Furthermore, not all applications require a GNSS based position.

Apparatus 100 illustrated in FIG. 1 and the operation illustrated in FIG. 2 may be implemented and refined in various ways.

The at least one communication network could comprise for instance a cellular communication network, like a global system for mobile communications (GSM) network, a 3rd Generation. Partnership Project (3GPP) based network like a wide-band code division multiple access (WCDMA) network or a time division synchronous CDMA (TD-SCDMA) network, a 3GPP2 network like a CDMA2000 network, a long term evolution (LTE) or LTE-Advanced network, or any other type of cellular communication network, like a worldwide interoperability for microwave access (WiMAX) system. The node of a cellular communication network could be for instance a transceiver or a base station of the cellular communication network. In general, a node of a cellular communication network could be any entity serving exactly one cell, or any entity serving a plurality of cells from a single position. Alternatively or in addition, the at least one communication network could comprise for example one or more networks of a non-cellular communication system, like WLAN, Bluetooth, Bluetooth Low Energy (BTLE) and Zigbee, etc. The node of a WLAN could be a WLAN access point.

Certain embodiments of the invention, in which the at least one communication network comprises a cellular communication network, may have the effect that a positioning is possible at more locations than, for instance, with a satellite signal based positioning, a WLAN based positioning or a Bluetooth based positioning. For instance, indoors, the reception of cellular signals may work better than the reception of satellite signals, while WLAN APs and Bluetooth beacons may not be available everywhere. It is to be understood that data on characteristics of a node of a cellular communication network may comprise or consist of data on characteristics of one or more cells served by the node.

In an exemplary embodiment, the measurements at the mobile device are measurements that are performed for another purpose than determining the position of the mobile device. Such measurements may be for instance cellular measurements that are preformed for handling handovers of the mobile device between cells when moving around. The use of the results of measurements that are available in any case may have the effect of limiting the processing power that is required for the location monitoring process and thus of ensuring that a continuous positioning may not burden the apparatus inappropriately. The measurement results could comprise for instance signal strength measurement values and/or path loss estimates. In the case of measurements on WLAN signals, it would be possible only to listen to WLANs for the measurements. This may require less power than a scanning for WLANs, which may be needed for detecting and accessing a particular WLAN.

In an exemplary embodiment, the data with the characteristics of nodes are received from a server.

In an exemplary embodiment, the data on characteristics of nodes are based on results of measurements, which comprise signal strength measurement values and/or path loss estimates. Mobile devices providing the measurement results and an identification of nodes and/or cells may provide at the same time an indication of their current position, in order to enable an identification of a position for which the measurement results are valid. Fingerprint data for a node could then comprise results of measurements associated with grid points of at least one virtual grid, with each grid point representing a real location. It is to be understood, however, that a mapping to grid points of a grid is not essential. In certain embodiments, it would also be possible to store results of measurements along with the actual location of measurement as fingerprint data, for example a location as provided by a mobile device providing the respective results of measurements. The fingerprint data for a node may be used for generating further models for the node, like at least one coverage area, a node position or at least one radio channel model.

In an exemplary embodiment, the data on characteristics of nodes may comprise an indication of at least one coverage area of a node. Alternatively or in addition, they may comprise an indication of a position of a node. Alternatively or in addition, they may comprise values of parameters of at least one radio channel model for a node.

Alternatively or in addition, they may comprise at least one set of fingerprint data for a node.

Providing simply an indication of a position of a node as the data on characteristics of a node might be an option for instance with networks supporting timing advance measurements, like GSM networks, universal mobile telecommunications system (UMTS) terrestrial radio access time division duplexing (UTRA-TDD) networks or LTE networks. Timing advance measurements on signals exchanged with the node could then be used for determining a distance of the device to the node.

A radio channel model could comprise for instance a pathloss model or a received signal strength model. In an exemplary embodiment, the radio channel model parameters comprise an apparent transmit power and/or a path loss constant and/or a path loss exponent and/or covariance matrix parameters. A subset of these parameters allows determining the path loss or the signal strength of signals transmitted by a node that a mobile device can be expected to detect at a certain distance to the node. The information required for defining a radio channel model may be quite compact and requires a limited amount of storage space or transmission bandwidth. A complete radio channel model for a node may comprise in addition the position of the node.

The coverage area of nodes may be suited to enable determination of a fairly rough position of the mobile device without much processing power. Fingerprint data or radio channel models may be suited to enable determination of a more accurate position of the mobile device using some more processing power. Obtaining an accurate position may also reduce the risk of triggering an action at a wrong position, when the action is required or desired in a rather limited area or at a rather precise position only. Information on coverage areas and radio channel models or fingerprint data could also be used in combination for determining a position of the mobile device.

In an exemplary embodiment, determining a position of the mobile device may comprise determining latitude and longitude values of a current position of the mobile device. In addition, an uncertainty for determined latitude and longitude values of a current position of the mobile device could be determined. Alternatively, determining a position of the mobile device may comprise for instance determining a presence of the mobile device in an area. Determining the current co-ordinates of the mobile device or its presence in an area could be performed, for instance, by determining the presence of the mobile device in the intersection of the coverage areas of a plurality of nodes. Alternatively or in addition, the current co-ordinates of the mobile device or its presence in an area could be determined by evaluating signal strength measurements or pathloss measurements at the mobile device in view of a radio channel model for at least one node. Alternatively or in addition, the current co-ordinates of the mobile device or its presence in an area could be determined by evaluating timing advance measurements.

The determined position can be used in various ways.

In an exemplary embodiment, the determined position is checked against location information stored in the mobile device. An action associated with location information may then be triggered whenever the determined position meets a condition defined by the location information. This may have the effect that the action may be triggered only at a promising and/or desired location. For instance, for certain proximity services, a mobile device may tie certain operations to the existence or proximity of specific nodes or beacons. With exemplary embodiments, the existence or proximity of such nodes or beacons may only be checked when the mobile device is already assumed to be close to such a node or beacon. As a result, the power consumption of a conventional proximity service may be reduced significantly.

In an exemplary embodiment, the determined position could meet the condition defined by the location information at least one of: when the determined position corresponds to a location defined by the location information, for instance with a defined uncertainty, when the determined position indicates that the mobile device enters an area defined by the location information, when the determined position indicates that the mobile device leaves an area defined by the location information, when the determined position indicates that the mobile device is located inside of an area defined by the location information, and when the determined position indicates that the mobile device is located outside of an area defined by the location information. The location information could define the condition by defining only a location or an area, or by defining in addition how the location or area is to be taken into account. It is to be understood that the latter could also be defined separately.

The location information stored in the mobile device could comprise for instance an indication of at least one area served by at least one WLAN. If the at least one WLAN is a home WLAN of a user or another particular WLAN, an action that is associated with the location information could comprise scanning for WLANs for determining whether a particular WLAN access point can be accessed at the current location of the mobile device. If the at least one WLAN comprises a plurality of WLANs, an action associated with the location information could comprise scanning for WLANs which can be used for positioning purposes.

Similarly, the location information stored in the mobile device could comprise for instance an indication of at least one area served by at least one Bluetooth enabled device. An action associated with the location information could then comprise for instance scanning for Bluetooth enabled devices for determining whether a particular Bluetooth enabled device is in range for exchanging signals. Instead of Bluetooth enabled devices, nodes of any other non-cellular communication system, like Zigbee, could be considered.

The location information stored in the mobile device could equally comprise for instance an indication of at least one area served by at least one digital living network alliance compliant device. An action associated with the location information could then comprise for instance establishing a connection to a digital living network alliance compliant device.

The location information stored in the mobile device could equally comprise for instance an indication of at least one area in which a satellite signal based positioning is to be performed. Such at least one area might comprise areas with good satellite signal reception in general, but it could equally comprise at least one area in which a particularly accurate positioning is desired for some reason. An action associated with the location information could then comprise for instance activating a satellite signal receiver of the mobile device.

The location information stored in the mobile device could also relate to various other kinds of triggers. It could comprise for instance an indication of an area in which advertisements may be received and/or presented to a user. It could further comprise an indication of an area in which an alarm is to output to a user. For example, when located at a particular position, the user may request the device to provide a particular kind of alarm when reaching the position the next time. The location information could also comprise an indication of an area in which some other kind of notification is to be provided to a user. The location information could also comprise an indication of an area in which settings of the mobile device are to be changed. The location could not only be defined by recording a current position of the device, but also for example by entering co-ordinates or an address via a user interface, or by means of a map presented on a display. For instance, a user could point to or otherwise select a shopping center on a map displayed by the mobile device and instruct the device to provide a notification, like a shopping list, when entering the pointed out area. As soon as the user enters the area, the notification may then be triggered, for instance by presenting the shopping list on the display. Thus, an action associated with the location information could comprise for instance as well presenting an advertisements to a user, outputting an alarm to a user, providing a notification to a user, or changing settings of the mobile device, like changing a phone profile when leaving home, etc.

Since certain embodiments of the invention allow limiting the use of network resources and/or power consumption and thus enable an always-on positioning, it becomes feasible to tie location information to almost all possible other content and functionalities as well.

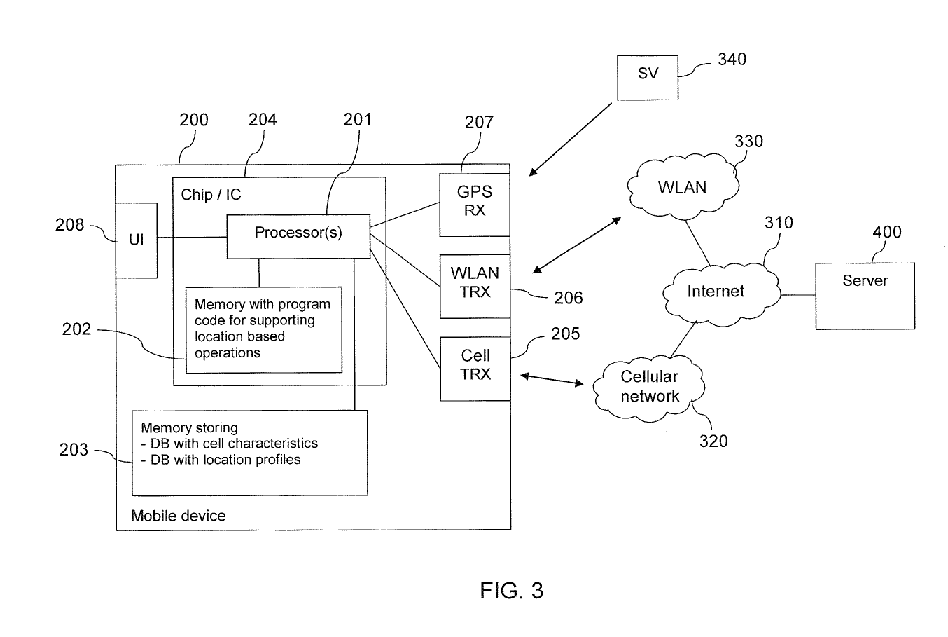

FIG. 3 is a schematic block diagram of a system supporting the use of location based operations.

The system comprises a mobile device 200. The system further comprises a network 310, for instance the Internet, and, linked to network 310, at least one cellular network 320, a plurality of WLANs 330, and a server 400. The system further comprises space vehicles (SV) 340.

Cellular communication network 320 comprises a plurality of base stations operating as nodes of the network. Each WLAN 320 comprises at least one access point. Each of the nodes and access points transmits signals that can be observed in a certain associated area. In the case of a cellular communication network 320, the area may comprise the area of one or more cells. The space vehicles 340 are satellites of at least one global navigation satellite system, for instance the global positioning system (GPS), Galileo and/or GLONASS.

Server 400 may provide or support a system for building up and updating a fingerprint database and/or a radio channel model database. It is configured to exchange information with other devices, like mobile device 200 or other servers, via network 310. Server 400 could also belong to network 310.

Mobile device 200 may be a smart phone or a laptop or any other kind of mobile device that is able to receive signals of at least one cellular communication network 320. It comprises a processor 201 that is linked to a first memory 202, to a second memory 203, to a cellular transceiver (TRX) 205, to a WLAN transceiver 206, to a GPS receiver (RX) 207 or any other GNSS receiver, and to a user interface 208.

Processor 201 is configured to execute computer program code, including computer program code stored in memory 202, in order to cause mobile device 200 to perform desired actions. Memory 202 stores computer program code for supporting the use of location based operations. The computer program code may comprise for example at least similar program code as memory 102. Memory 202 could comprise in addition program code for realizing location based operations. In addition, memory 202 may store computer program code implemented to realize other functions, as well as any kind of other data. Processor 201 and memory 202 may optionally belong to a chip or an integrated circuit 204, which may comprise in addition various other components, for instance a further processor or memory.

Memory 203 stores at least one database (DB) that is configured to comprise data on characteristics of cells of cellular network 320, as exemplary data on characteristics of nodes of a communication network. Memory 203 further stores a database with location profiles. Each profile defines at least one area and at least one associated action. It is to be understood that the databases could also be distributed to different memories instead. In addition, memory 203 could store any other data. Memory 203 could be an integrated memory of mobile device 200 or a removable memory.

Cellular transceiver 205 is configured to exchange signals with base stations of cellular communication network 320. Cellular transceiver 205 may comprise a complete cellular engine, but various functions required for a cellular communication may also be realized by other components of mobile device 200, for instance by processor 201 executing suitable program code.

WLAN transceiver 206 is configured to access WLAN access points of WLANs 330. Various functions required for a communication via a WLAN access point may also be realized by other components of mobile device 200, for instance by processor 201 executing suitable program code.

GPS receiver 207 is configured to receive and process satellite signals from GPS satellites 340. This may include the capability of performing a positioning of mobile device 200 and providing the position to processor 201 for further use. Alternatively, GPS receiver 207 could be configured to provide data on satellite signals to processor 201 for enabling processor 201 to perform satellite signal base positioning computations using appropriate software code.

User interface 208 may include a display and/or loudspeakers for presenting information to a user, a keyboard and/or a touchscreen for enabling a user input and/or any other means enabling a user to communicate with mobile device 200.

Component 204 or mobile device 200 could correspond to exemplary embodiments of an apparatus according to the invention.

It is to be understood that the distribution of functions to components is only exemplary and could be realized in may different ways.

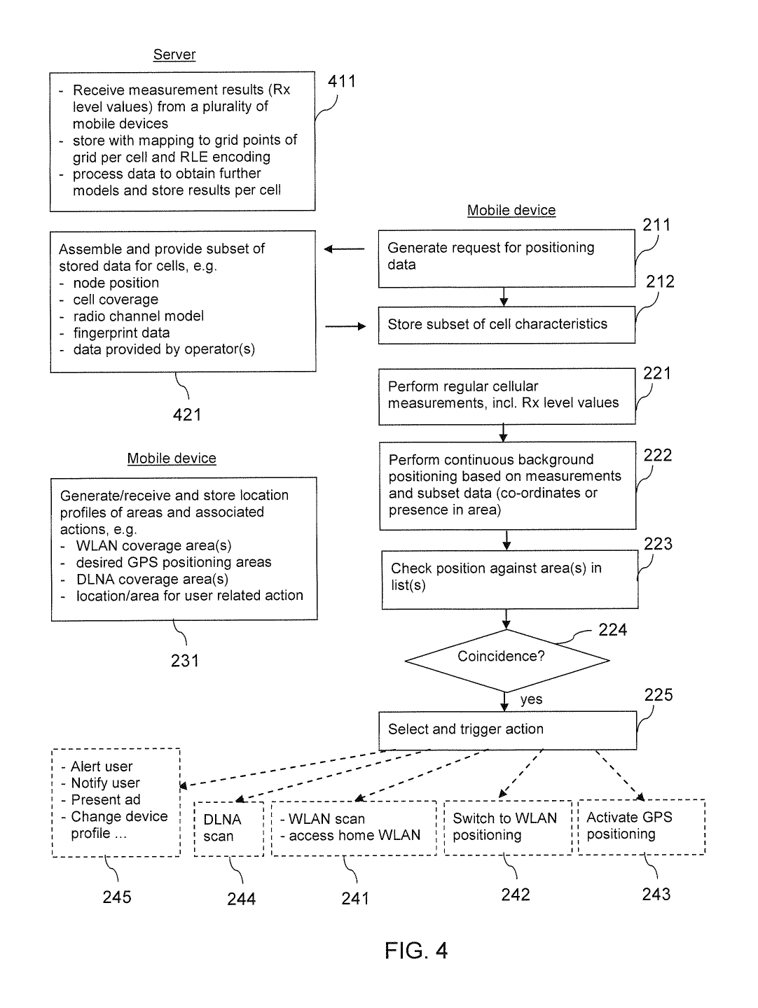

An exemplary operation in the system of FIG. 3 for supporting the use of location based operations will now be described with reference to the flow chart of FIG. 4. FIG. 4 illustrates actions at server 400 and actions at mobile device 200. Processor 201 and the program code stored in memory 202 cause mobile device 200 to perform the presented actions 211 to 244 when program code is retrieved from memory 202 and executed by processor 201. It is to be understood that the program code may comprise different pieces and that execution of different pieces may be started independently.

Various mobile devices may determine their current position based, for example, on received satellite signals. In addition, the mobile devices may detect signals transmitted by one or more nodes of cellular network 320 for a respective cell. The mobile devices may assemble results of measurements on these signals, including Rx level values as an indication of received signal strengths. They may further associate an identification of a cell and thus of the node, with the result or results for at least one cell, for instance a global cell identity and/or a local cell identity. The mobile devices may then transmit the measurement results and the associated identifications along with an indication of the determined position as a fingerprint to server 400.

Server 400 receives such fingerprints from a plurality of devices and stores received Rx level values and possibly additional data in a fingerprint database. (action 411)

For the fingerprint database, a respective virtual grid may be defined to cover at least an area in which signals of a cell can be detected, have been detected or are assumed to be detectable. Each grid point may correspond to a real location. The measurement results could be associated with grid points of a grid that represent locations close to the respective measuring position, that is, the indicated position of the mobile devices. This may have the effect that results of measurements can be stored efficiently, that is, for a limited number of locations and thus with a limited amount of data. The data may be stored in various ways. Each grid could be represented for instance by a table that is stored in the fingerprint database, and the measurement results and associated data could be inserted as an entry of the table. It is to be understood, however, that the storage of the data for a cell does not require storage of the entire grid or of a table corresponding to the entire grid. Since many grid points may not have any data associated with them so far, the data could be stored for instance efficiently using a run-length encoding in the fingerprint database.

The stored Rx level data may be used for regularly updating further models that are stored in a database on a per cell basis. The further models may comprise for instance the coverage area of a respective cell, or radio propagation models for a respective cell along with a position of the node.

Server 400 may receive, store and process measurement results continuously, to keep the databases up to date.

Mobile device 200 may generate a request for assistance data for a cellular positioning and transmits the request to server 400. (action 211) Such a request may be generated for instance upon a user request, when a user wishes to make use of location based operations, or automatically in regular intervals, optionally upon confirmation by a user.

Server 400 receives the request and assembles and provides a subset of stored data. (action 421) The subset may comprise the node position of a plurality of nodes, an indication of the coverage area of a plurality of cells served by the nodes, radio channel model parameters for a plurality of cells, and/or selected fingerprint data. The data may be limited to data on cell characteristics of cells in a particular country, in a particular region or belonging to a particular operator, etc.

Mobile device 200 receives the subset of the stored data and stores the data in memory 203. (action 212)

It is to be understood that additional data could also be obtained from mobile operators and stored in memory 203, for instance the node positions. In an exemplary embodiment, mobile operators could provide such data for instance to server 400, which may then forward the data to mobile device 200 along with the subset of stored data.

Mobile device 200 may further perform regular cellular measurements, including a determination of Rx level values of a serving node and of neighboring nodes. (action 221) Such measurements may be performed anyhow, for instance in order to handle handover processes. A typical receiving cycle with current mobile phones may be in the order of a few seconds so that cellular measurements may be frequently be available without increase in power consumption. The measurements may be continuous in that they are performed at frequent intervals, for instance at least once per minute.

Mobile device 200 may perform in addition a continuous positioning, based on the results of the measurements in action 221 and based on the stored subset of data on cell characteristics. (action 222) Thus, mobile device 200 may be kept location-aware in the background. The positioning may be continuous in that it is performed at frequent intervals, for instance at least one per minute.

It is to be understood that in certain conditions the measurements in action 221 and/or the positioning operations in action 222 may be interrupted. That is, measurements and positioning operations could be performed continuously only at certain times. For instance, in case mobile device 200 comprises a sensor subsystem providing motion state information, internally requesting and performing measurements may be stopped whenever the sensor subsystem indicates that mobile device 200 is stationary. In another exemplary embodiment, the measurements could still be requested and performed if mobile device 200 is indicated to be stationary, but the position might not be determined; or the position could be determined and filtered with the stationary assumption.

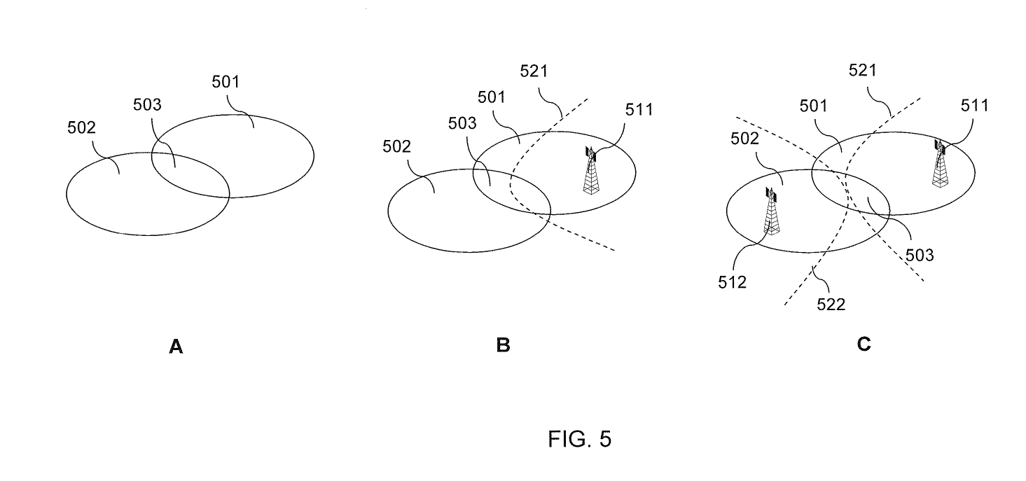

The actual positioning can be performed in various ways. FIG. 5 is a diagram illustrating some possibilities.

The positioning may result in an area in which the mobile device is assumed to be located, or in co-ordinates at which the mobile device is assumed to be located. Such co-ordinates may be combined with an uncertainty, which may be predetermined or a cell specific value that is determined at server 400 based on the crowd sourced data and provided in addition to mobile device 200 in action 421.

In an approach illustrated in FIG. 5A, mobile device 200 may be determined to be located in the overlapping part 503 of the coverage areas 501, 502 of cells. In an approach illustrated in FIG. 5B, the radio channel model for a node 511 serving cell 501 may be taken into account in addition to overlapping area 503. A dashed line 521 represents the locations at which an exemplary signal strength of signals transmitted by node 511, which corresponds to a currently measured received signal strength at the mobile device for node 511, can be expected. In an approach illustrated in FIG. 5C, the radio channel model for node 511 serving cell 501 and the radio channel model for at least one further node 512 serving a further cell 502 may be taken into account in addition to overlapping area 503. A dashed line 522 represents the locations at which an exemplary signal strength of signals transmitted by node 512, which corresponds to a currently measured received signal strength at the mobile device for node 512 can be expected. An intersection point or touching point of lines 521 and 522 in area 503 may then be considered as estimate for the location of mobile device 200. Obviously, only the locations in area 503 have to be taken into account when determining the locations represented by lines 521 and 522, which may reduce the processing load. Similarly as signal strength or pathloss, a measured timing advance could be used for determining the position of a device. If the position of a node is known, the timing advance measurements indicate the distance to the node and thus information on a position of the mobile device.

Other approaches may be used as well for determining the current position of mobile device 200 based on the stored data on cell characteristics.

Furthermore, the positioning performance may be improved by further processing the determined positions. For instance, static positioning fixes could be filtered in the time-domain for an outlier detection, etc. Other filtering schemes are also possible.

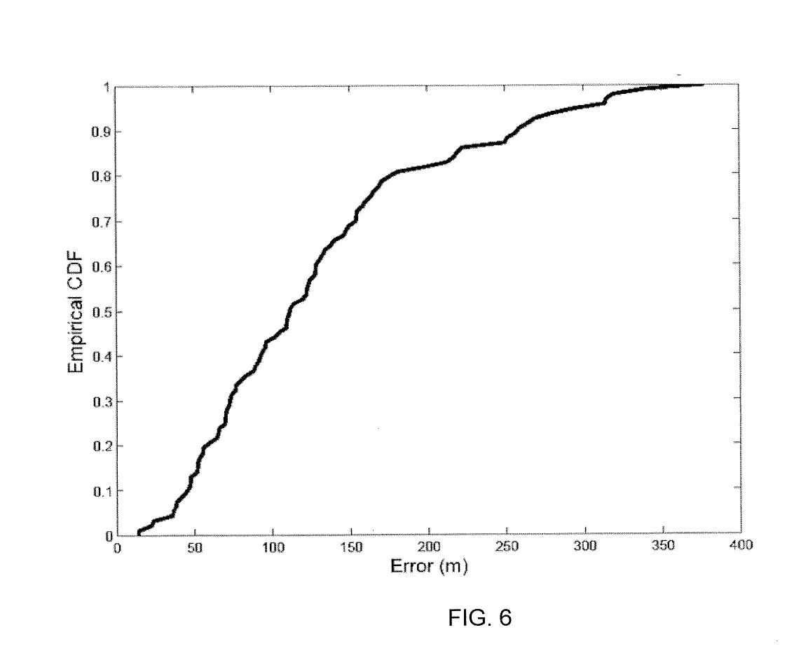

A cell based positioning using radio channel model parameters can be fairly exact. This can be seen for example in FIG. 6, which is a diagram presenting an empirical cumulative distribution function for the error in meters that resulted with a cell-based continuous positioning in an exemplary urban environment, using a dual mode mobile device. The dual mode device supported both GSM and WCDMA networks. The network mode could change at any time, thus at some times the positioning was based on GSM cells and at other times it was based on WCDMA cells. The position was determined based on coverage area information only. The mean error was 131 m, the median error was 112 m and the 95%-consistency was 95%.

In order to be able to support an automatic triggering of certain actions at certain locations, mobile device 200 furthermore generates and stores one or more location profiles, including an identification of areas and associated actions. (action 231) The location profile or profiles may be generated taking into account a user input via user interface 208. Some information on the areas and/or on the actions may be received at mobile device 200 from another device, for instance from a server via network 310 and cellular communication network 320, or via network 310 and network 310 and a WLAN 330.

In case an automatic switch to a home WLAN for accessing network 310 is desired by a user, a location profile may comprise for instance information on the coverage area of the home WLAN and a definition of actions causing the mobile device 200 to try to switch to access network 310 via the home WLAN 330 instead of a cellular communication network 320. When the user configures his home WLAN to mobile device 200, mobile device 200 may tie position information, as calculated in action 222, to the access point configuration. More specifically, a WLAN system in mobile device 200 may register itself for location events, with minimum moving hysteresis to avoid an unnecessary amount of events. The event can be “notify when near this WLAN AP”. The location profile could thus comprise a definition of an area close to the WLAN AP and an associated action “notify the WLAN system”.

In case a WLAN based positioning is desired by a user whenever usable WLANs are close by, a location profile may comprise information on the coverage areas of WLANs 330 that are available for such positioning and a definition of actions causing the mobile device 200 to try to switch to a WLAN based positioning. Information on the coverage areas of WLANs and, optionally, associated MAC addresses might be provided by some server. This information might equally be based on crowd sourced data. The information on the WLANs could be provided to mobile device 200 for instance by server 400 together with the data on the cells of the cellular communication network, in case server 400 collects and processes as well measurements on signals from WLAN access points. If the WLAN based positioning is performed on the network side, mobile device 200 might only need a list of areas in which WLAN based positioning can be performed. If the WLAN based positioning is performed on the device side, mobile device 200 might store in addition associated MAC addresses in order to be able to perform the positioning. A WLAN based positioning may have the effect that it is more precise than a cellular based positioning.

In case a GPS based positioning is desired by a user at certain locations, a location profile may comprise information on areas corresponding to these locations and a definition of actions causing mobile device 200 to activate a GPS based positioning. A GPS based positioning may have the effect that it is more precise than a positioning that is based on terrestrial signals. Information on the areas corresponding to desired locations might be provided by some server. Alternatively, a user might cause mobile device 200 to store for instance a respective area based on a position determined in action 222, when mobile device 200 is known to be located in one of the areas.

In case the use of services of one or more DLNA servers may be desired, a location profile may comprise information on the coverage areas of the desired DLNA servers and a definition of actions causing mobile device 200 to try to connect to the DLNA server. The area of a respective DLNA server may be defined for instance by position information, calculated at mobile device 200 in action 222, that is valid the first time that mobile device 200 is close to the DLNA server and the user of mobile device 200 expresses an interest in regularly using services of this DLNA server.

A location profile could also comprise information on a particular location or area that is linked to a definition of some user related action of mobile device 200.

It is to be understood that a multitude of other use cases are possible as well.

It is further understood that if the generation of location profiles does not rely on positions that are estimated in action 222, it could also take place before cell characteristics are requested and received in actions 211, 212. In this case, the location profile might also have an influence on the subset of data that is requested. For instance, if a location profile is generated for automatically starting WLAN scans at suitable positions, only data on the characteristics of cells in the vicinity of the corresponding WLAN access points might be requested and received.

Mobile device 200 may further check a respective position determined in action 222 against the area or areas defined in stored location profile or profiles, if any. (action 223)

If there is no coincidence (action 224), either because there is no location profile or because there no match with a defined area in a location profile is found, mobile device 200 may simply continue with measurements, background positioning and checking (actions 221-224). Location profiles may be added or deleted (action 231).

If there is a coincidence between the determined position and an area defined in a stored location profile (action 224), mobile device 200 may select an action that is associated to this area and trigger the action. (action 225) It is to be understood that in some embodiments, a coincidence may require detection of a new match, if it is to be monitored whether an area is entered for triggering an action. It is further to be understood that the area could also be defined implicitly as an area lying outside of an explicitly defined area, if it is to be monitored whether mobile device 200 is located outside of the explicitly defined area or leaves the explicitly defined area for triggering an action.

In this case, mobile device 200 may still continue with performing measurements, background positioning and checking (actions 221-224), because other actions may be associated to other areas in some location profile. However, the location profile for which a coincidence has been found might be ignored in the further checking in action 223, until an operation that is caused by the action associated to this location profile has been stopped for some reason. If there is only a single location profile or if actions have been triggered for all stored location profiles, actions 223 to 225 may be paused until one of the operations that are caused by the actions associated to areas in the location profiles has been stopped for some reason. The cellular measurements (action 221) may continue, though, since they may be needed for other purposes as well. The positioning in action 222 might still be of use for supporting the potential generation of new location profiles.

If the selected action that is to be triggered relates to accessing a home WLAN, triggering the action might comprise starting a scan for the home WLAN or informing a registered. WLAN system. (action 241) In an exemplary embodiment, a WLAN system in mobile device 200, which is registered to be informed when mobile device 200 is near home WLAN AP, may then start the WLAN scans. When the home WLAN is found in the scan, a connection may be established.

Mobile terminals could perform periodic WLAN scans to determine if a configured WLAN AP, like a home WLAN AP, is visible or not. However, if location information is continuously available as in the presented embodiment, and the location of the WLAN AP has been linked to the MAC address of the WLAN AP, mobile device 200 does not have to perform periodical WLAN scans. Instead, such scans are only performed when mobile device 200 is known to be close to the configured AP. This may have the effect that the battery consumption is reduced significantly due to the decreased number of WLAN scans. Reducing battery consumption improves the usability of mobile device 200 and thus the user experience with the device. The presented continuous positioning enables in addition the connection to a home WLAN without the time delays that may be caused by periodic WLAN scans.

If the selected action that is to be triggered relates to a WLAN based positioning, triggering the action might comprise starting periodic scans for WLANs in general. (action 242) This ensures that it is avoided that WLAN scans are performed when there are no WLANs nearby. Limiting automatic WLAN scans to certain areas may have the effect that power may be saved at mobile device 200. The results of the scans may then be used to make the cellular based positioning result more accurate by means of a WLAN-based positioning.

If the selected action that is to be triggered relates to a GPS based positioning, triggering the action might comprise activating a GPS positioning. (action 243) GPS positioning may be used for instance for obtaining a precise information on a position for triggering some further action when some triggering condition is met. For instance, when it is determined that a position estimated in action 223 coincides with an area in a location profile that corresponds to the coverage area of a Bluetooth beacon, mobile device 200 might first activate GPS positioning to determine an accurate position of mobile device 200, and try to establish a connection to the Bluetooth beacon only once also the GPS position indicates that mobile device 200 is located sufficiently close to the Bluetooth beacon.

Carrying out a GPS positioning all the time simply for checking, whether this further triggering condition is met, is a power-consuming task. Running GPS periodically in the background for checking, if the further triggering condition is met, means that the system can miss the trigger depending on the check interval. However, when combining the presented continuous cellular based positioning with a precise GPS based positioning, or any other GNSS based positioning, in particular areas, the detection of triggering conditions may be sufficiently reliable, accurate and battery saving to be interesting for commercial use cases.

If the selected action that is to be triggered relates to accessing a DLAN server, triggering the action might comprise starting a scan for DLAN servers. (action 244) Thus, there is only an attempt to connect to a DLNA server in an area in which the DLNA server can be assumed to be accessible.

If the selected action that is to be triggered is user related, triggering the action might comprise alerting a user, presenting a notification to a user, presenting an advertisement to a user, changing a device profile, etc. (action 245)

The presented approach could also be used for many other use cases. It could be used for instance for enabling location based advertisement without requiring a high power consumption or risking that mobile devices frequently miss the point where the advertisement is valid.

A mobile device having a stored location profile and stored data on node characteristics may thus use this information for supporting an automatic triggering of any desired location based operation.

Furthermore, the position determined in action 222 could also be used immediately, without checking it against stored location information. It could be used for instance for storing an indication of the estimated position to various types of data that is entered or generated by a user at the time of positioning. Such data might be captured pictures, messages, entries in a diary of a road trip, entries of a to-do list, etc.

Summarized, certain embodiments of the invention may thus enable an on-device-positioning service that is suited to continuously provide a position in a trustable manner and without extensive consumption of battery or network resources. This may allow making use of the position of a mobile device in many applications either more efficiently or feasible for the first time.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or 201 in combination with memory 102 or 202, respectively, or the integrated circuit 204 can also be viewed as means for performing continuous measurements on terrestrial signals transmitted by nodes of a communication network to obtain results of measurements; and means for continuously determining a position of the mobile device based on the results of measurements at the mobile device and based on data stored in the mobile device, the data including data on characteristics of nodes of at least one communication network that are based at least partly on results of measurements at a plurality of mobile devices on terrestrial signals transmitted by nodes of the at least one communication network.

The program codes in memory 102 and 202, respectively, can also be viewed as comprising such means in the form of functional modules.

FIGS. 2 and 4 may also be understood to represent exemplary functional blocks of a computer program code for supporting the use of location based operations.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-24. (canceled)

25. A method comprising at a mobile device:
performing continuous measurements on terrestrial signals transmitted by nodes of a communication network to obtain results of measurements; and
continuously determining a position of the mobile device based on the results of measurements at the mobile device and based on data stored in the mobile device, the data including data on characteristics of nodes of at least one communication network that are based at least partly on results of measurements at a plurality of mobile devices on terrestrial signals transmitted by nodes of the at least one communication network.

26. The method according to claim 25, wherein the measurements at the mobile device are measurements that are performed for another purpose than determining the position of the mobile device.

27. The method according to claim 25, wherein data on characteristics of nodes are received from a server collecting and processing results of measurements provided by the plurality of mobile devices.

28. The method according to claim 25, wherein the data on characteristics of nodes comprise at least one of:
an indication of at least one coverage area of a node;
an indication of a position of a node;
values of parameters of at least one radio channel model for a node; and
at least one set of fingerprint data for a node.

29. The method according to claim 25, wherein determining a position of the mobile device comprises at least one of:
determining latitude and longitude values of a current position of the mobile device;
determining an uncertainty for determined latitude and longitude values of a current position of the mobile device;
determining a presence in an area;
determining a presence in an intersection of coverage areas of a plurality of nodes;
evaluating signal strength measurements in view of a radio channel model for at least one node;
evaluating pathloss measurements in view of a radio channel model for at least one node; and
evaluating timing advance measurements.

30. The method according to claim 25, further comprising:
checking the determined position against location information stored in the mobile device; and
triggering an action associated with location information whenever the determined position meets a condition defined by the location information.

31. The method according to claim 30, wherein the determined position meets the condition defined by the location information at least one of:
when the determined position corresponds to a location defined by the location information;
when the determined position indicates that the mobile device enters an area defined by the location information;
when the determined position indicates that the mobile device leaves an area defined by the location information;
when the determined position indicates that the mobile device is located inside of an area defined by the location information; and
when the determined position indicates that the mobile device is located outside of an area defined by the location information.

32. The method according to claim 30, wherein the location information stored in the mobile device comprises at least one of:
an indication of at least one area served by at least one wireless local access network;
an indication of at least one area served by at least one Bluetooth enabled device;
an indication of areas in which a satellite signal based positioning is to be performed;
an indication of at least one area served by at least one digital living network alliance compliant device;
an indication of an area in which advertisements may be received;
an indication of an area in which an alarm is to be output to a user;
an indication of an area in which a notification is to be provided to a user; and
an indication of an area in which settings of the mobile device are to be changed.

33. The method according to claim 30, wherein an action associated with location information comprises at least one of:
scanning for wireless local access networks for determining whether a particular wireless local access network access point can be accessed at a current location of the mobile device;
scanning for wireless local access networks which can be used for positioning purposes;
scanning for Bluetooth enabled devices for determining whether a particular Bluetooth enabled device is in range for exchanging signals;
activating a satellite signal receiver of the mobile device;
establishing a connection to a digital living network alliance compliant device;
presenting an advertisements to a user;
outputting an alarm to a user;
providing a notification to a user; and
changing settings of the mobile device.

34. An apparatus comprising at least one processor and at least one memory including computer program code, the at least one memory and the computer program code configured to, with the at least one processor, cause a mobile device at least to perform:
perform continuous measurements on terrestrial signals transmitted by nodes of a communication network to obtain results of measurements; and
continuously determine a position of the mobile device based on the results of measurements at the mobile device and based on data stored in the mobile device, the data including data on characteristics of nodes of at least one communication network that are based at least partly on results of measurements at a plurality of mobile devices on terrestrial signals transmitted by nodes of the at least one communication network.

35. The apparatus according to claim 34, wherein the measurements at the mobile device are measurements that are performed for another purpose than determining the position of the mobile device.

36. The apparatus according to claim 34, wherein the at least one memory and the computer program code are configured to, with the at least one processor, cause the mobile device to receive data on characteristics of nodes from a server collecting and processing results of measurements provided by the plurality of mobile devices.

37. The apparatus according to claim 34, wherein the data on characteristics of nodes comprise at least one of:
an indication of at least one coverage area of a node;
an indication of a position of a node;
values of parameters of at least one radio channel model for a node; and
at least one set of fingerprint data for a node.

38. The apparatus according to claim 34, wherein determining a position of the mobile device comprises at least one of:
determining latitude and longitude values of a current position of the mobile device;
determining an uncertainty for determined latitude and longitude values of a current position of the mobile device;
determining a presence in an area;
determining a presence in an intersection of coverage areas of a plurality of nodes; and
evaluating signal strength measurements in view of a radio channel model for at least one node;
evaluating pathloss measurements in view of a radio channel model for at least one node; and
evaluating timing advance measurements.

39. The apparatus according to claim 34, wherein the at least one memory and the computer program code are further configured to, with the at least one processor, cause the mobile device to:
check the determined position against location information stored in the mobile device; and
trigger an action associated with location information whenever the determined position meets a condition defined by the location information.

40. The apparatus according to claim 39, wherein the determined position meets the condition defined by the location information at least one of:
when the determined position corresponds to a location defined by the location information;
when the determined position indicates that the mobile device enters an area defined by the location information;
when the determined position indicates that the mobile device leaves an area defined by the location information;
when the determined position indicates that the mobile device is located inside of an area defined by the location information; and
when the determined position indicates that the mobile device is located outside of an area defined by the location information.

41. The apparatus according to claim 39, wherein the location information stored in the mobile device comprises at least one of:
an indication of at least one area served by at least one wireless local access network;
an indication of at least one area served by at least one Bluetooth enabled device;
an indication of areas in which a satellite signal based positioning is to be performed;
an indication of at least one area served by at least one digital living network alliance compliant device;
an indication of an area in which advertisements may be received;
an indication of an area in which an alarm is to be output to a user;
an indication of an area in which a notification is to be provided to a user; and
an indication of an area in which settings of the mobile device are to be changed.

42. The apparatus according to claim 39, wherein an action associated with location information comprises at least one of:
scanning for wireless local access networks for determining whether a particular wireless local access network access point can be accessed at a current location of the mobile device;
scanning for wireless local access networks which can be used for positioning purposes;
scanning for Bluetooth enabled devices for determining whether a particular Bluetooth enabled device is in range for exchanging signals;
activating a satellite signal receiver of the mobile device;
establishing a connection to a digital living network alliance compliant device;
presenting an advertisements to a user;
outputting an alarm to a user;
providing a notification to a user; and
changing settings of the mobile device.

43. The apparatus according to claim 34, wherein the apparatus is one of:
a mobile device; and
a component for a mobile device.

44. A non-transitory computer readable storage medium in which computer program code is stored, the computer program code when executed by a processor causing an apparatus to perform the following:
performing continuous measurements on terrestrial signals transmitted by nodes of a communication network to obtain results of measurements; and
continuously determining a position of the mobile device based on the results of measurements at the mobile device and based on data stored in the mobile device, the data including data on characteristics of nodes of at least one communication network that are based at least partly on results of measurements at a plurality of mobile devices on terrestrial signals transmitted by nodes of the at least one communication network.
